(19) United States
(12) Patent Application Publication
(10) Pub. No.: US 2025/0126324 A1
(43) Pub. Date: Apr. 17, 2025

(54) BANDWIDTH PRESERVATION THROUGH SELECTIVE APPLICATION OF ERROR MITIGATION TECHNIQUES FOR VIDEO FRAME REGIONS

(71) Applicant: NVIDIA Corporation, Santa Clara, CA (US)

(72) Inventors: Johannes Zimmermann, Berlin (DE); Andrija Bosnjakovic, Redmond, WA (US)

(73) Assignee: NVIDIA Corporation, Santa Clara, CA (US)

(21) Appl. No.: 18/485,483

(22) Filed: Oct. 12, 2023

(51) Int. Cl. H04N 21/442; H04N 19/136; H04N 19/146; H04N 19/172; H04N 19/174; H04N 19/65; H04N 21/462; H04N 21/6437

(52) U.S. Cl. CPC H04N 21/44245; H04N 21/4621; H04N 21/6437; H04N 19/136; H04N 19/146; H04N 19/172; H04N 19/174; H04N 19/65

(57) ABSTRACT

In various examples, systems and methods are disclosed relating to bandwidth preservation through selective application of error mitigation techniques for video frame regions. A subset of network packets for a video stream are identified as corresponding to an encoded region of a video frame of the video stream. At least one error correction packet is transmitted for the subset that encodes the region of the video frame. The network packets and the at least one error correction packet can be transmitted to a receiver device.

### BACKGROUND

Video streaming involves encoding and transmitting video data over a network to a remote client device, which subsequently decodes the video. One drawback to video streaming is the occurrence of lost video data during streaming, which may be caused by factors such as network latency and packet loss. Error mitigation techniques, such as the transmission of forward error correction (FEC) packets, may reduce instances of lost data in video streams. However, transmission of such error mitigation data may reduce the bandwidth available for video data in low-latency streaming applications, such as game streaming.

### SUMMARY

Embodiments of the present disclosure relate to bandwidth preservation through selective application of error mitigation techniques for video frame regions. Systems and methods are disclosed that improve upon the drawbacks of conventional error mitigation techniques in video streaming by selectively transmitting error mitigation information for selected sets of network payload, which may be carrying relevant portions of the streamed encoded video data. Conventional systems transmit error mitigation packets generated for the entirety of the video stream and therefore increase overall consumption of network bandwidth, which can result in higher latency, slower transmission speeds, and lower available bitrate for video quality. The techniques described herein reduce overall network bandwidth consumption by employing additional error mitigation for regions of video frames that are deemed most important to the application for which the video is streamed (hereinafter “selected regions”).

At least one aspect is related to a processor. The processor can include one or more circuits. The one or more circuits can identify, from a plurality of network packets corresponding to an encoded video stream, a subset of network packets corresponding to a region of a video frame of the video stream. The one or more circuits can generate at least one error correction packet for the subset of network packets that encode the region of the video frame. The one or more circuits can transmit, to a receiver client device, the plurality of network packets and the at least one error correction packet.

In some implementations, the plurality of network packets are transmitted via user datagram protocol (UDP). In some implementations, the encoded video stream is formatted in compliance with the real-time transport protocol (RTP). In some implementations, the one or more circuits can generate the encoded video stream. In some implementations, the one or more circuits can generate the plurality of network packets. In some implementations, at least one network packet of the plurality of network packets can include a portion of the encoded video stream corresponding to the region of the video frame.

In some implementations, the one or more circuits can select the region of the video frame based at least on a configuration associated with the video stream. In some implementations, the selected region of the video frame comprises one or more slices or one or more tiles of the video frame. In some implementations, the region is a selected region. In some implementations, the one or more circuits can allocate a first percentage of bandwidth for the encoded video stream to one or more first error correction packets for the subset of network packets that carry the selected region of the video frame.

In some implementations, the one or more circuits can allocate a second percentage of bandwidth for the video stream to one or more second error correction packets for a packet sequence that carries regions of the video frame other than the selected region. In some implementations, the at least one error correction packet comprises forward error correction (FEC) data generated based at least on the subset of associated network packets. In some implementations, the encoded video stream comprises an encoded bitstream generated according to a video codec standard such as h.264 (AVC), h.265 (HEVC), h.266 (VVC), AV1, VP8, or VP9, among other suitable codecs.

At least one aspect is related to another processor. The processor can include one or more circuits. The one or more circuits can detect, based at least on a subset of a sequence of network packets received from a streaming server, that at least one network packet of the sequence of network packets was not successfully received by an intended receiver. The one or more circuits can determine that the at least one network packet corresponds to a selected region of a video frame of a video stream. The one or more circuits can transmit a request for retransmission of the at least one network packet responsive to determining that the at least one network packet corresponds to the selected region and responsive to determining an available bandwidth allocation for retransmission of important regions of video and that a round-trip delay (RTD) to the streaming server is within a predetermined range.

In some implementations, the sequence of network packets is received via a communication protocol such as UDP. In some implementations, the video stream is formatted in compliance with RTP. In some implementations, the one or more circuits can delay or skip transmission of the request responsive to determining that the available bandwidth allocation for retransmission of important regions of video has been exhausted or that the round-trip delay (RTD) to the streaming server is outside a predetermined range.

At least one aspect is related to a method. The method can include identifying, by using one or more processors, from a plurality of network packets corresponding to an encoded video stream, a subset of network packets corresponding to an encoded region of a video frame of the video stream. The method can include generating, using one or more processors, at least one error correction packet for the subset of network packets that carry the encoded region of the video frame. The method can include transmitting, using one or more processors, to a receiver client device, the plurality of network packets and the at least one error correction packet.

In some implementations, the plurality of network packets are transmitted via UDP. In some implementations, the video stream is formatted in compliance with RTP. In some implementations, the method includes generating, using the one or more processors, the encoded video stream. In some implementations, the method includes generating, using the one or more processors, the plurality of network packets. In some implementations, each network packet of the plurality of network packet comprises a portion of the encoded video stream corresponding to the region of the video frame. In some implementations, the method includes selecting, using the one or more processors, the region of the video frame based at least on a configuration associated with the video stream.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for three-dimensional (3D) assets, a system for performing deep learning operations, a system implemented using an edge device, a system implemented using a robot, a system for performing conversational AI operations, a system for generating synthetic data, a system incorporating one or more language models, a system incorporating one or more virtual machines (VMs), a system implemented at least partially in a data center, or a system implemented at least partially using cloud computing resources.

### BRIEF DESCRIPTION OF THE DRAWINGS

The present systems and methods for bandwidth preservation through selective application of error mitigation techniques for streamed video frame regions are described in detail below with reference to the attached drawing figures, wherein:

FIG. 1 is a block diagram of an example system for bandwidth preservation through selective application of error mitigation techniques for streamed video frame regions, in accordance with some embodiments of the present disclosure;

FIG. 2 depicts an example diagram of a video frame constructed from encoded regions that may be rendered by the system shown in FIG. 1, in accordance with some embodiments of the present disclosure;

FIG. 3 is a flow diagram of an example of a method for bandwidth preservation through selective application of error mitigation techniques for streamed video frame regions, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods that implement bandwidth preservation through the selective application of error mitigation techniques to packets corresponding to selected (e.g., important or relevant) regions of frames in a video bitstream. Examples of the error mitigation techniques include FEC, packet retransmission, and invalidation of a segment of the video bitstream. At a high level, the bandwidth preservation techniques described herein can be performed by a streaming server that transmits a video stream to a client device. In some implementations, the video stream can be transmitted as part of a remote gaming application.

Important or relevant regions of the video stream may be any region of the frame that is perceptually important, perceived by user to be important or critical, or is designated as relevant by an application that generates the video frames. The important or relevant regions may be regions of frames of the video stream that a user is more likely to focus on relative to other regions of the frames. The important or relevant regions may be regions of frames of the video stream that are more frequently updated with new information, relative to other regions of frames of the video stream. Such regions may be selected for additional error mitigation.

In some embodiments, a video stream may be communicated as a sequence of network packets that carry the payload of encoded video and transport-related metadata. The video stream can be provided by the streaming server using a suitable media streaming protocol, such as RTP, which may utilize UDP as its transport facility. Video streams transmitted via such protocols can implement error correction techniques, such as FEC, which enable the client device to correct for transmission errors or lost data in video streams. Without error correction in video streaming, lost packets result in pixelation, freezing, or other types of video artifacts or errors.

Error correction techniques, such as FEC, involve transmitting additional network packets that include error correction data along with the original network packets that include the video stream. The additional error correction data may take the form of redundant data. The client device receiving the video stream from the streaming server uses this additional data to correct errors (e.g., data corruption) or the original network packets that may have been lost during transmission. For example, in RTP video streaming, the streaming server can send FEC packets, which contain redundant information generated based at least on the original network packets transmitted as part of the video stream. The client device receiving the video stream can use these packets to recover lost packets and reconstruct the original video stream in real-time.

However, using error correction techniques in real-time video streaming requires additional bandwidth to transmit the additional error correction data. This increased consumption of network bandwidth can result in higher latency, slower transmission speeds, and lower available bitrate for video quality, all of which sum up to reduced overall quality of user experience. Additionally, error correction data in real-time video streams may increase the processing requirements of the client device, because the client device must process and decode the additional error correction data, which can increase the amount of time needed to process the real-time video stream. These issues are particularly pronounced in low-latency streaming applications, such as remote gaming applications.

To mitigate the downsides of error correction in video streaming while preserving the benefits of error correction, the systems and methods described herein implement selective error correction for portion(s) of the encoded video stream corresponding to region(s) of video frames that include relevant information. Regions that are relevant may be regions that are deemed relatively more important for particular applications or video streams. By selectively generating and transmitting error correction data only for portion(s) of the encoded video stream corresponding to region(s) of video frames that are most likely to include relevant information, the systems and methods described herein can reduce overall bandwidth consumption of the video stream while fundamentally retaining the benefits of error correction.

Video streams transmitted via protocols such as RTP utilize video codecs, which may encode video frames in multiple distinct regions. The geometric regions may include one or more horizontal slices, tiles, sequence(s) of macroblocks, any other logical sub-unit of a video frame that may be encoded as a distinct part of the encoded video frame's bitstream and decoded as a distinct part of the decoded video frame's data. The size and type of each region may be specified based at least on the video codec used to encode the video stream. In certain video streaming applications, such as remote game streaming, users are expected to focus at certain geometrical regions of their viewport (e.g., near the center of the video, near certain edges of the video, certain corners of the video, areas where increased levels of pixel changes are occurring, etc.), while paying less attention to other, subjectively less relevant regions. Error mitigation can be selectively applied to the relevant regions of the video stream that users are expected to focus on, in order to preserve the integrity and usability of the streamed video data while reducing the impact on bandwidth consumption.

To implement selective error mitigation, the streaming server can identify the regions (e.g., slices, tiles, etc.) of the video stream that users are expected to focus on and then selectively generate additional error correction data for the packets that encode the video data for those regions. The streaming server can prioritize resources for the identified regions, for example, by reserving a greater percentage of the error correction data allocated for the video stream for the selected regions, rather than uniformly distributing error correction data for equally for all regions of the stream. In some implementations, the streaming server may also generate a comparatively lower amount of error correction data for non-selected regions of the video frame compared to the selected regions of the frame. In some implementations, the streaming server may forego generating error correction data for non-selected regions of the video frame.

In some implementations, additionally or alternatively, the client device receiving the video stream may request retransmission of packets that encode selected portions of the encoded video stream corresponding to selected regions of the video frame. For example, the client device may identify which packets of the video stream encode relevant data, and subsequently request retransmission only for such packets. By requesting retransmission of packets that include only relevant data, the number of retransmission requests transmitted by the client device is reduced on average. In some implementations, selected portions of the encoded video stream corresponding to selected regions of the video frame may utilize the complete bandwidth available for error correction, but then intentionally issue retransmission requests only on significant losses or not at all. For example, the client device may determine not to use packet retransmission on detection of a lost packet but instead only issue a retransmission request when even the increased error correction information is not enough to reconstruct the transmitted portion of the encoded video bitstream.

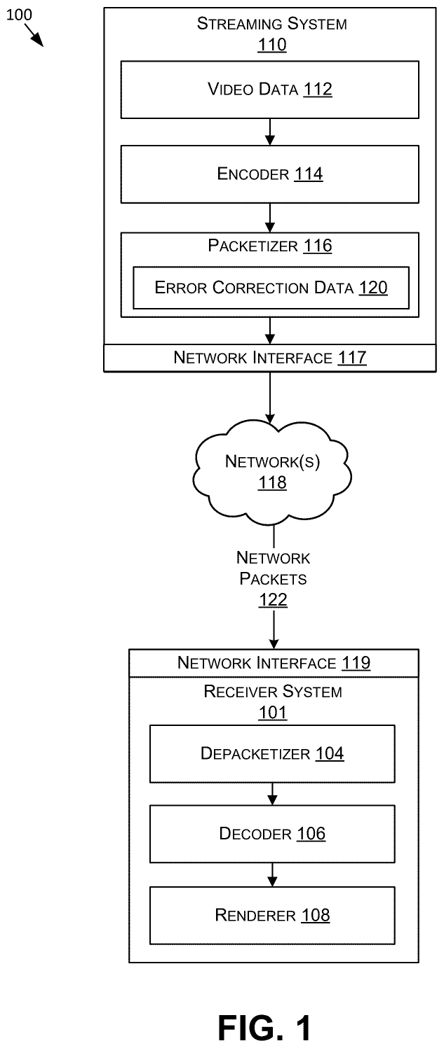

With reference to FIG. 1, FIG. 1 is an example computing environment including a system for bandwidth preservation through selective application of error mitigation techniques for video frame regions, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 can be utilized to provide (e.g., stream) video data 112 and error correction data 120 as part of one or more network packets 122 via the network 118 to a receiver system 101, which may utilize the error correction data to recover network packets 122 carrying video data that were corrupted or lost during transmission. The video data 112 may correspond to video frames of a video stream generated from any suitable source, including a video playback process, a gaming process (e.g., video output from remotely executed video games), among other sources of video data. In some implementations, the streaming system 110 can execute one or more applications or games that generate the video data 112.

The video data 112 can be generated as an output of any process that generates frames of video information. In some implementations, the video data 112 may be generated as an output of a rendering process for a video game executed by the streaming system 110. In a remote gaming configuration, the streaming system 110 may execute one or more game applications and may receive input data transmitted from the receiver system via the network 118 to control the game applications. Frames of the video data 112 may be generated at a predetermined frame rate, including but not limited to thirty frames-per-second, sixty frames-per-second, and so on.

The encoder 114 of the streaming system 110 can encode the video data into a suitable format for transmission by generating an encoded bitstream according to one or more codecs. Encoding the video data 112 reduces the overall amount of information that is to be transmitted to the receiver system 101. The encoder 114 may utilize any combination of hardware or software to encode the video data 112. Encoding the video data 112 can include converting the video data 112 to conform to any suitable codec standard, including but not limited to codec standards such as h.264 (AVC), h.265 (HEVC), h.266 (VVC), AV1, VP8, VP9, or any other video codec that supports geometrical regions of a video frame. Similar codecs may be utilized to encode audio data. The encoder 114 can generate the encoded bitstream continuously, for example, as frames are generated by an application or source of the video data. The encoder 114 may generate the encoded bitstream to include a chronological sequence of encoded video frames.

Encoding the video data 112 may include segmenting each video frame of the video data 112 into one or more regions. The encoder 114 can then encode each frame region (e.g., slice or tile) so it can be included in the encoded bitstream, where each encoded slice or tile therefore corresponds to a respective region of a video frame. The geometry of the regions may be rectangular slices, tiles, contiguous sequence(s) of macroblocks, or any other logical sub-unit of a video frame that may be encoded as a distinct part of the encoded video frame's bitstream and decoded as a distinct part of the decoded video frame's data. In some implementations, a region may have the same width as the video frame (e.g., a horizontal slice). To render an encoded bitstream, a downstream decoder (e.g., the decoder 106 described in further detail herein) can decode each encoded region of the encoded bitstream and provide the decoded data to a renderer (e.g., the renderer 108) to generate a complete video frame. In some implementations, each encoded region of the encoded bitstream may be a single decodable unit of encoded video data, which may be rendered independently from other encoded regions of a video frame.

The encoder 114 can perform various compression techniques to encode the video data 112. For example, the encoder 114 may perform intra-frame compression techniques, inter-frame compression techniques, and rate control compression techniques, including but not limited to motion estimation, quantization, and entropy coding. In some implementations, the encoded bitstream may include audio data, which may be generated by the encoder 114 using a suitable audio encoding process. In some implementations, audio data may be formatted as a separate bitstream.

In some implementations, the encoder 114 can determine whether generated regions (e.g., slices or tiles) of a video frame of the video data 112 include selected content, which may be “relevant” or “important” content to which an end-user is likely to focus on. For example, in a remote gaming application, the end-user may be more likely to focus on the center or certain edges of the video frame, because these regions may include data that is more relevant to gameplay than other regions. Any number of regions of the video frame may be indicated as important or relevant. Unselected regions of the video frame may be regions of the video frame to which a user is less likely to focus on, or may include information that is updated at a less frequent basis.

To do so, when dividing a video frame of the video data 112 into discrete regions (e.g., slices or tiles), the encoder 114 can compare the location (e.g., coordinates) of each slice or tile to a set of coordinates that indicate a selected region. If the location of the slice or tile is within the coordinates that indicate a selected region, the encoder 114 can flag the slice or tile as a selected region of the frame. In some implementations, the encoder 114 can generate the encoded bitstream to include metadata that indicates whether and which encoded regions are selected.

In some implementations, the coordinates of selected regions are predetermined and application agnostic. In some implementations, the coordinates of selected regions of frames of the video data 112 may be application-specific, and may be stored in association with the application producing the video data 112. For example, the application producing the video data 112 (e.g., a game application rendering frames of the video data 112) may be stored in association with one or more configuration settings or files that indicate which regions (e.g., coordinates) of the frames of video data 112 are most relevant or most important for streaming. The encoder 114 can retrieve the information corresponding to the application and use it to flag corresponding regions as selected.

In some implementations, the coordinates of the frames of the video data 112 may be dynamically determined. For example, as the application rendering frames of the video data 112 is executed, the regions of the screen to which a user is most likely to focus on may change. To compensate for these changes, the encoder may access a set of coordinates that indicate the important regions of the frame based at least on the current state of the application. The state of the application may be provided by the application, may be determined by the encoder via one or more application programming interface (API) calls, or may be determined based at least on the frames of the video data 112 produced by the application. As new frames of the video data 112 are rendered, the encoder 114 can access the most up-to-date coordinates for the current state of the application to dynamically determine which regions of the frames of the video data 112 are selected.

Flagging the encoded regions of a video frame as selected may include generating metadata that is separate from the encoded bitstream, which is provided to the packetizer 116 as described herein to generate the error correction data 120. In some implementations, the encoder 114 may insert or otherwise include indications that an encoded region of a frame is selected within the encoded bitstream generated by the encoder 114. Once the encoder 114 has generated the encoded bitstream, the encoded bitstream and any indications of selected encoded regions, can be provided as input to the packetizer 116.

To do so, the packetizer 116 can divide the encoded bitstream into one or more parts, and can include these parts in the payload of a sequence of network packets 122. The network packets 122 may be, for example, UDP packets or other suitable transport-level packets. The payload of the network packets 122 may include one or more streaming protocol packets, which themselves include the portions of the encoded bitstream in their respective payloads. The streaming protocol packets may be generated, for example, according to the RTP protocol, or any other protocol that provides a mapping between subsets of portions of the encoded bitstream corresponding to frame regions and streaming protocol packets.

The packetizer 116 can divide the encoded bitstream into parts that are each included in payloads of respective RTP packets. In some implementations, an RTP packet payload may include encoded information (e.g., a portion of the encoded bitstream) corresponding to a single region (e.g., a single slice or tile) of a frame of the video data 112. In some implementations, an RTP packet payload may include encoded information corresponding to multiple regions of a frame of the video data 112 (e.g., multiple slices or tiles). In some implementations, an RTP packet payload may include encoded information corresponding to a part of the portion of the encoded bitstream corresponding of a region of a frame of the video data 112, such that multiple RTP packets are utilized to construct the portion of the encoded bitstream corresponding to a frame region of the video data 112.

In an example implementation utilizing RTP, the packetizer 116 may generate a mapping between each network packet 122 and a corresponding frame region of video data by including a sequence number that indicates the order in which the packets should be arranged for decoding and rendering. The sequence number may be utilized by a downstream depacketizer to identify which packets in a sequence of network packets 122 have been dropped. In some implementations, additional data (e.g., metadata) that designates an identifier or a location of the frame region of the encoded bitstream may be included in the payload of each network packet 122.

The packetizer 116 can generate the network packets 122 to accommodate various characteristics of the network. The network packets 122 may be transport protocol packets that may not guarantee reliability of packet delivery. One example of such a protocol is UDP. An advantage of utilizing packets that do not guarantee delivery is decreased latency due to the lack of built-in error checking and reliability checked performed when using transport protocols that guarantee delivery of packets. In some implementations, the packetizer 116 may generate the network packets 122 to include video streaming protocol data that satisfies the size of the maximum transmission unit (MTU) of the network 118, which is the maximum size of a packet that can be transmitted over the network without being fragmented. To do so, the packetizer 116 may, in some implementations, split regions of frames into multiple RTP payloads to satisfy the MTU limitation. In some implementations, payloads of multiple RTP packets can be included in each of the network packets 122.

The packetizer 116 can generate the error correction data 120 for transmission with packets that store the encoded bitstream of the frames of the video data 112. The error correction data 120 may be utilized by the receiver system 101 to correct errors that may occur during data transmission. Prior to generating the error correction data 120, the packetizer 116 can generate the network packets 122, which carry the encoded bitstream in one or more video streaming packets. The packetizer 116 can then generate error correction data 120, which can be utilized by the receiver system 101 to recover original data carried by network packets 122 that were lost or corrupted during transmission. The error correction data 120 may include FEC data, which may be computed from payloads of the video streaming network packets 122 generated by the packetizer 116.

In the example of FEC, the error correction data 120 may be transported together with network packets 122 that carry the selected encoded regions of a video frame. In some implementations, the packetizer 116 can generate additional network packets 122 that include the error correction data 120 as respective payloads. To generate the error correction data, the packetizer 116 can apply an FEC encoding algorithm to the payload data of the network packets 122 that include the encoded bitstream data. Some example encoding algorithms include Reed-Solomon encoding, Hamming encoding, Low-Density Parity-Check (LDPC) encoding, Turbo encoding, Raptor encoding, Tornado encoding, Fountain encoding, Convolutional encoding, Bose-Chaudhuri-Hocquenghem (BCH) encoding, Golay encoding, Reed-Solomon product (RS-product) encoding, and Polar encoding, among others.

The packetizer 116 may generate network packets 122 that include the error correction data 120 for each of the network packets 122 that include selected encoded regions of the video data 112 in their payloads. As described herein, the packetizer 116 can flag or otherwise indicate which portions of the encoded bitstream correspond to selected regions of a frame of the video data 112. Rather than generating error correction data 120 for all network packets 122 uniformly, the packetizer 116 can generate error correction data 120 for the selected regions of the encoded bitstream. In some implementations, the packetizer 116 can generate additional network packets 122 that include only the error correction data 120 for the selected regions of the bitstream as a payload. The network packets 122 that are generated to include the error correction data 120 may be generated to conform to an MTU of the network 118, as described herein.

In some implementations, the percentage of the network packets 122 for which error correction data 120 is generated may be based upon a percentage configuration. For example, the packetizer 116 may generate error correction data for a predetermined percentage of the network packets 122, with a bias towards generating error correction data 120 for packets that store selected portions of the encoded bitstream. In some implementations, the packetizer 116 may generate error correction data 120 proportional to the importance of the regions stored in the payloads of the network packets 122. The error correction data 120 may be generated as a predetermined percentage of the sequence of network packets 122 for a frame of the video data 112. Within that predetermined percentage, the packetizer 116 can generate error correction data 120 that is weighted towards network packets 122 carrying selected regions of the video frame. In a non-limiting example where a video frame has a 20% bandwidth “budget” for error correction data 120, the packetizer 116 may generate a number of packets carrying error correction data 120 equal to 20% of the generated network packets 122 for the video frame. A weighted proportion of the generated error correction data 120 for the video frame may be generated for network packets 122 carrying selected regions of the video frame, while the remainder of the error correction data 120 budget may be generated for network packets 122 carrying unselected regions of the video frame. In one example, 75% of the error correction data 120 for a video frame may be generated for network packet(s) 122 carrying selected region(s) of the video frame, while the remaining 25% can be generated for the remaining network packets 122 carrying unselected regions of the video frame.

The percentage of network packets 122 for which the error correction data 120 is generated may be a function of the bandwidth allocated for streaming the video data 112. For example, the packetizer 116 can allocate a first percentage of bandwidth for transmitting the encoded bitstream to the error correction data 120 generated for network packets 122 that carry the selected regions of a video frame, and allocate the remaining percentage of the bandwidth, if any, to the error correction data 120 generated for the network packets 122 that do not carry the selected regions of the video frame. The percentage of bandwidth occupied by the error correction data 120 may be a function of the capabilities of the network.

In some implementations, the packetizer 116 can dynamically modify the percentage of the bandwidth allocated to the error correction data 120. For example, the streaming system 110 may receive requests for retransmission of packets from the receiver system 101, and increase bandwidth allocated to the error correction data 120 as a function of the frequency of the requests for transmission. In some implementations, the packetizer 116 can set the bandwidth allocated to the error correction data 120 itself constant, and instead dynamically modify the percentage of error correction data 120 that is generated for the network packets 122 that store the selected regions of the video frame. In some implementations, the packetizer 116 can dynamically modify both the percentage of bandwidth allocated to the error correction data 120, and the percentage of the error correction data 120 that is generated for the selected regions of the video frame. In some implementations, error correction data 120 may only be generated for network packets 122 that store selected regions of the frame.

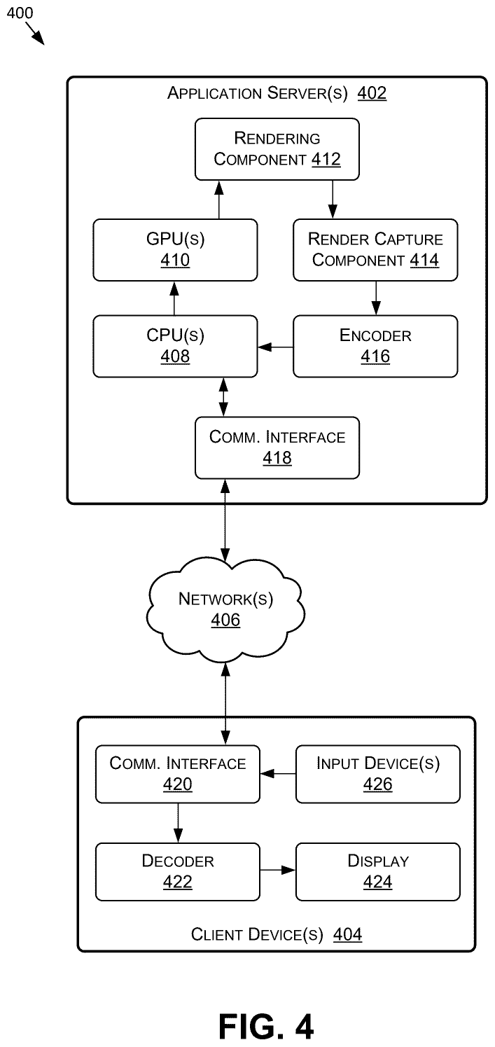

The network packets 122 generated by the packetizer 116, including network packets 122 that store the generated error correction data 120, can then be transmitted to the receiver system 101 as shown. In some implementations, the packetizer 116 may retransmit a particular network packet 122 upon receiving a request for transmission of said network packet 122 from the receiver system 101. The network packets 122 can be transmitted via the network interface 117 of the streaming system 110. The network interface 117 of the streaming system 110 may include any of the structure of, and implement any of the functionality of, the communication interface 418 described in connection with FIG. 4.

The receiver system 101 may be any computing system suitable to receive and process network packets 122 as described herein. The receiver system 101 can receive the network packets 122 via the network interface 119. The network interface 119 of the receiver system 101 may include any of the structure of, and implement any of the functionality of, the communication interface 420 described in connection with FIG. 4. In some implementations, the receiver system 101 may include or may be in communication with a display device that can present decoded video data based at least on the network packets 122. The decoded video data may be, for example, video data generated from a remote game or remote application executing on the streaming server. The receiver system 101 may utilize packet recovery techniques by decoding some or all received error correction data 120 upon detecting instances of lost or corrupted network packets 122.

The depacketizer 104 of the receiver system 101 can receive the network packets 122 transmitted from the streaming system 110 and assemble one or more decodable units of video data to provide to the decoder 106. As described herein, the network packets 122 may be generated according to a protocol that does not guarantee delivery. Therefore, when assembling the decodable units of video data (e.g., decodable regions of the encoded bitstream), the depacketizer 104 can determine whether one or more network packets 122, and therefore one or more regions of the encoded bitstream, were lost during transmission.

Upon receiving the network packets 122 from the streaming system 110, the depacketizer 104 can store and reorder the RTP packets included in the received network packets 122. To do so, the depacketizer 104 may utilize the sequence number of each RTP packet in the network packets 122 to ensure that the packets are reconstructed in the correct order. For example, the depacketizer 104 extracts the RTP packets from the payload of the network packets 122 and can store the RTP packets in a container, indexed by the sequence number of each RTP packet. As new network packets 122 are received, the depacketizer 104 can access the sequence number in the header of each RTP packet and store the RTP packet in the container in the correct order. In some implementations, the depacketizer 104 may discard any duplicate packets.

Once the RTP packets have been reordered and any duplicates have been discarded, the depacketizer 104 can reassemble the encoded bitstream transmitted by the streaming system 110 by concatenating the payload of each RTP packet in the correct order. For example, the encoded bitstream may correspond to a frame of the video data 112, and the depacketizer 104 can reassemble the encoded bitstream corresponding to the frame based at least on the payloads of each RTP packet. In doing so, the depacketizer 104 can determine that one or more network packets 122 have been lost if a missing sequence number in the sequence of RTP packets is identified. For example, RTP packets may have consecutive sequence numbers, or sequence numbers that change based at least on a predetermined pattern. The depacketizer 104 can scan through the container storing the RTP packets and determine whether there are any sequence numbers that are missing. The depacketizer 104 can flag any such packets as lost.

Upon detecting that one or more network packets 122 are lost, the depacketizer 104 can attempt to reconstruct any lost payload data using received error correction data 120. For example, in addition to storing the payload data corresponding to the video stream in a container, the depacketizer 104 can store any received error correction data in one or more data structures in memory of the receiver system 101. To do so, the depacketizer 104 can perform a corresponding decoding algorithm to decode the information encoded in the error correction data 120. The decoding algorithm can correspond to the encoding algorithm used by the packetizer 116 to generate the error correction data 120. Decoding the error correction data 120 can include processing both the received payload data of the network packets 122 and the received error correction data 120 to recover the lost or corrupted payloads.

After recovering the lost or corrupted payload data using the decoding process of error correction data, the depacketizer 104 can reassemble the reconstructed payload data into its original form, and place the reconstructed data into the corresponding place in the container that stores the extracted RTP payloads. Reconstructing the information from the error correction data 120 may result in recovering lost or corrupted video data, enabling said lost data to be displayed even when it was lost in transport.

In some circumstances, the received error correction data 120 may be insufficient to reconstruct one or more lost network packets 122. For example, error correction data 120 that encodes lost information may also be lost in transport, or the number of lost network packets 122 were too significant to reconstruct with error correction data 120 alone. In such circumstances, the depacketizer 104 can determine whether to request retransmission of one or more network packets from the streaming system 110. To do so, the depacketizer 104 may determine whether the lost network packets 122 were carrying selected regions of the video data 112.

To do so, the depacketizer 104 can determine the portions of the encoded bitstream to which the dropped packets correspond. Because the encoded bitstream corresponding to the frame of the video data 112 is constructed from multiple RTP packets, the portions of the encoded bitstream to which the missing packets correspond will not be properly reconstructed. As described herein, the payloads of the RTP packets may include encoded bitstream data corresponding to a single frame region (e.g., a slice or a tile) or multiple frame regions, in whole or in part.

When assembling the encoded bitstream at the receiver system, the depacketizer 104 can identify portions of the encoded bitstream that are missing based at least on the RTP packets that were unable to be reconstructed using received error correction data 120. In doing so, the depacketizer 104 may transmit requests for retransmission only for lost network packets 122 that were carrying selected regions of a video frame, thereby reducing the overall bandwidth consumption of the system compared to requesting retransmission of all missing video data. In some implementations, the depacketizer 104 may not request retransmission of lost network packets 122 if those lost network packets 122 did not include selected regions of the video data 112.

In some implementations, the depacketizer 104 may transmit requests for retransmission of lost network packets 122 that were carrying selected regions of video data 112 if the bandwidth allocation for retransmission of packets has not been exhausted and round-trip delay (RTD) to the server is within a predetermined range (e.g., acceptable limits). For example, when establishing a streaming session between the streaming system 110 and the receiver system 101, an amount of bandwidth for data transfer between the streaming system 110 and the receiver system 101 can be established. A percentage of this bandwidth may be allocated to retransmission of network packets 122. The percentage of the bandwidth allocated to retransmission may be a function of the overall bandwidth for data transfer between the streaming system 110 and the receiver system 101. The RTD between the streaming system 110 and the receiver system 101 can be determined, for example, by periodically pinging the streaming system 110 and then analyzing timestamps included in the payload of the resultant network packets 122.

In some implementations, the amount of bandwidth allocated to retransmission of lost packets may be dynamically adjusted by the streaming system 110 or the receiver system 101 based at least on conditions of the network 118 or changes in a loss pattern of lost network packets 122, among other conditions. When the depacketizer 104 determines that a packet including data corresponding to a selected region of a video frame was dropped, the depacketizer 104 can then determine whether the bandwidth allocated for packet retransmissions has been exhausted. If the available bandwidth has not been exhausted, the depacketizer 104 can transmit a request for the streaming system 110 to retransmit the lost network packet(s) 122 that include the selected frame regions.

If the bandwidth has been exhausted, the depacketizer 104 may delay transmission of the request until bandwidth is available, or forego requesting retransmission of the lost packets 122 altogether. The depacketizer 104 may use any type or combination of network conditions to determine whether to delay or skip requesting retransmission of the lost packets 122. For example, the depacketizer 104 may determine whether the RTD between the streaming system 110 and the receiver system 101 satisfies predetermined limits. In some implementations, if the RTD exceeds the amount of time required to render the current frame, the depacketizer 104 may skip requesting retransmission of a lost packet 122. In some implementations, if the depacketizer 104 determines that delaying the request for retransmission due to excessive bandwidth use would likely exceed an amount of time before the next frame in the video stream is to be displayed, the depacketizer 104 may forego requesting retransmission of the network packet.

The decoder 106 can receive, parse, and decode the encoded bitstream assembled by the depacketizer 104. To do so, the decoder 106 can parse the encoded bitstream to extract any associated video metadata, such as the frame size, frame rate, and audio sample rate. In some implementations, the decoder 106 can identify the codec based at least on the metadata and decode the encoded bitstream using the identified codec to generate data video and/or audio data. In some implementations, such video metadata may be transmitted in one or more packets that are separate from the network packets 122 that include video data. This may include decompressing or performing the inverse of any encoding operations used to generate the encoded bitstream at the streaming system 110. The decoder 106, upon generating the decoded video data for a frame of video, can provide the decoded video frame data to the renderer 108 for rendering. In circumstances where video data is lost due to lost or corrupted network packets 122, the decoder 106 may implement one or more error concealment techniques to conceal errors in the ultimately rendered video.

The renderer 108 can render and display the decoded video data received from the decoder 106. The renderer 108 can render the decoded video data on any suitable display device, such as a monitor, a television, or any other type of device capable of displaying decoded video data. To do so, the renderer 108 can store the decoded video data in a frame buffer. The renderer 108 can then draw the frame buffer contents for the current frame to the display device. In some implementations, the renderer 108 may perform multiple layers of rendering, such as overlaying graphics or text on top of the video frames. In circumstances where video data is lost due to lost or corrupted network packets 122, the renderer 108 may implement one or more error concealment techniques to conceal errors in the ultimately rendered video.

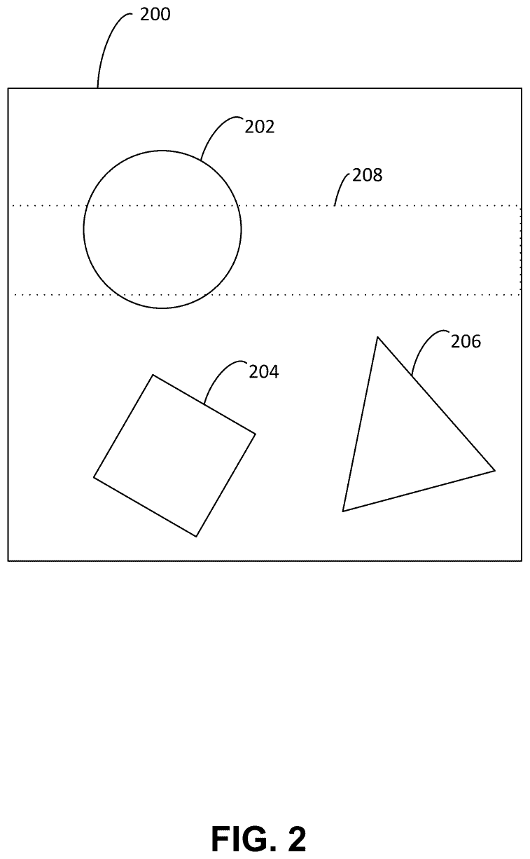

Referring to FIG. 2, depicted is an example diagram of a video frame 200 constructed from encoded regions 208 that may be rendered by the system shown in FIG. 1, in accordance with some embodiments of the present disclosure. As shown in FIG. 2, the frame 200 is shown depicting displayed objects such as the circle 202, the square 204, and the triangle 206 in initial positions. Other display elements such as displayed background are not shown for clarity. In this non-limiting example, a region 208 of the frame 200 is a horizontal strip that spans the width of the frame 200. The frame 200 includes other slices having the same size but are located at different locations of the frame 200. However, it should be understood that regions of the video frames described herein may include any geometric shape or configuration, such as rectangular or square tiles. Multiple frame regions are rendered together to form a complete, seamless image. If the region 208 is determined to be a selected region of interest, the packets that carry the encoded data corresponding to the region 208 may have additional error correction packet data associated therewith, as described herein.

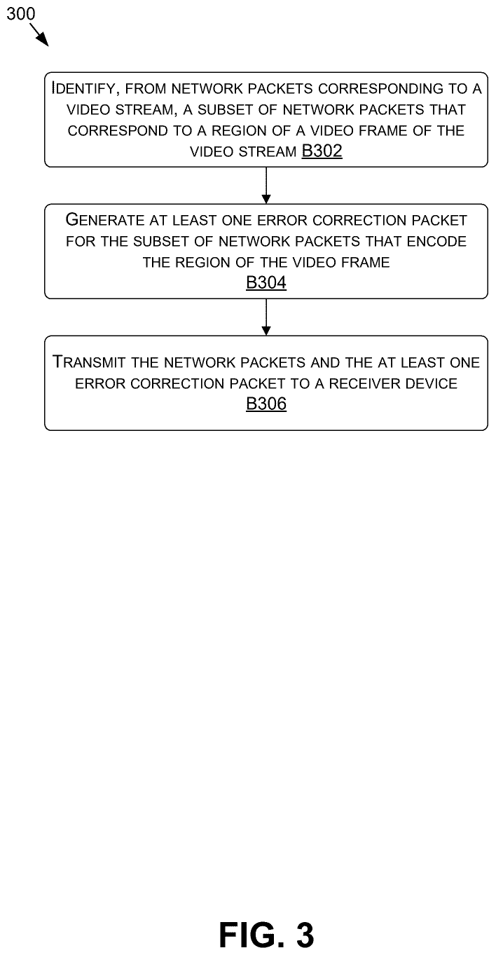

Now referring to FIG. 3, each block of method 300, described herein, includes a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for bandwidth preservation through selective application of error mitigation techniques for video frame regions, in accordance with some embodiments of the present disclosure. The method 300, at block B302, includes identifying network packets (e.g., the network packets 122) that correspond to a region of a video frame of an encoded video stream. The network packets may be generated by a streaming server (e.g., the streaming system 110) for transmission to a receiver system (e.g., the receiver system 101). The network packets may be UDP packets having payloads that include packets corresponding to a streaming protocol such as RTP, or any other streaming protocol that provides a mapping between subsets of frame regions and streaming protocol packets. The encoded bitstream can be encoded according to a video codec standard, such as (for example and without limitation), AVC (or h.264), HEVC (or h.265), VVC (or h.266), VP8, VP9, or AV1, among other suitable codecs. The encoded bitstream may encode regions of each frame of the video stream, where each region may have at least one dimension that is lesser than or equal to dimensions of the frame. To identify the network packets that correspond to the selected regions of the video, an appropriate component of the streaming server (e.g., the packetizer 116 of the streaming system 110) can determine which regions of the video frame are most likely to be focused on by an end user, and which packets include said encoded regions as part of their payloads.

The method 300, at block B304, includes generating at least one error correction packet for the subset of network packets that encode the region of the video frame. The error correction packet may be any network packet that includes error correction data (e.g., the error correction data 120). The error correction data may be FEC data, and may encode redundant information stored in the network packets that carry the encoded bitstream of the video. In some implementations, the error correction data may be generated by the streaming server (e.g., via the packetizer 116) according to a predetermined percentage of bandwidth available to transmit the video stream to the receiver system. In some implementations, a greater percentage of error correction packets may be generated for network packets that carry selected regions of the video data, as compared to network packets that carry relatively unselected (e.g., unimportant or irrelevant) regions of the video data.

The method 300, at block B306, includes transmitting the network packets and the at least one error correction packet to the receiver system. To do so, the network packets may be transmitted via a network interface (e.g., the network interface 117) over a network (e.g., the network 118), which ultimately delivers both the video streaming network packets and the at least one error correction network packet to the receiver system. If one or more of the network packets were lost during transmission, the receiver system (e.g., the depacketizer 104 of the receiver system 101) can utilize the at least one error correction packet, which can be decoded and utilized to reconstruct the information that was carried by the lost network packet(s). The reconstructed data, in addition to the data included the payloads of the received video streaming network packets, can be assembled into an encoded bitstream, which may be subsequently decoded (e.g., by the decoder 106) and rendered (e.g., by the renderer 108).

### Example Content Streaming System

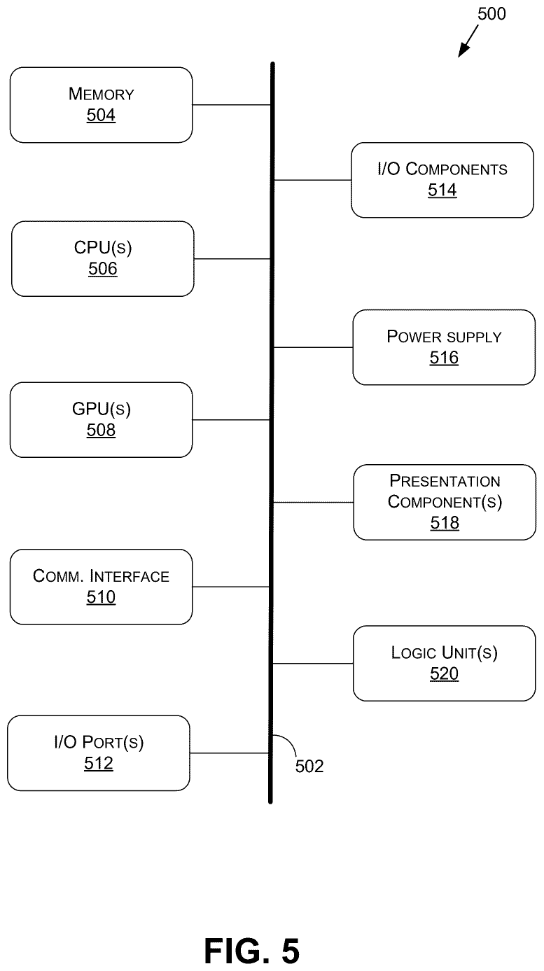

Now referring to FIG. 4, FIG. 4 is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 100 may be implemented by one or more components of the system 400 shown in FIG. 4. The application session may correspond to a game streaming application (e.g., NVIDIA Geforce NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 400, for an application session, the client device(s) 404 may only receive input data in response to inputs to the input device(s) 426, transmit the input data to the application server(s) 402, receive encoded display data from the application server(s) 402, and display the display data on the display 424. As such, the more computationally intense computing and processing is offloaded to the application server(s) 402 (e.g., rendering-in particular, ray or path-tracing-for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based at least on receiving the display data from the application server(s) 402. The application server(s) 402 may implement any of the functionality of the streaming server 110 described in connection with FIG. 1. The client device 404 may receive an input to one of the input device(s) 426 and generate input data in response. The client device 404 may transmit the input data to the application server(s) 402 via the communication interface 420 and over the network(s) 406 (e.g., the Internet), and the application server(s) 402 may receive the input data via the communication interface 418. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 412 may render the application session (e.g., representative of the result of the input data), and the render capture component 414 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques-of the application server(s) 402. In some embodiments, one or more virtual machines (VMs)—e.g., including one or more virtual components, such as vGPUs, vCPUs, etc.—may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424. The client device 404 may implement any of the functionality of the receiver system 101 described in connection with FIG. 1.

The systems and methods described herein may be used for a variety of purposes, by way of example and without limitation, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing, and/or any other suitable applications.

Disclosed embodiments may be used in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems incorporating one or more language models, systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may include one or more virtual machines (VMs), and/or any of the components thereof may include virtual components (e.g., virtual hardware components). For non-limiting examples, one or more of the GPUs 508 may include one or more vGPUs, one or more of the CPUs 506 may include one or more vCPUs, and/or one or more of the logic units 520 may include one or more virtual logic units. As such, a computing device 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may include computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system). Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not include signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be implemented/configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be implemented/configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506) and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLink) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be implemented/configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g.,

Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., to a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. A NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.) and output the data (e.g., as an image, video, sound, etc.).

### Example Data Center

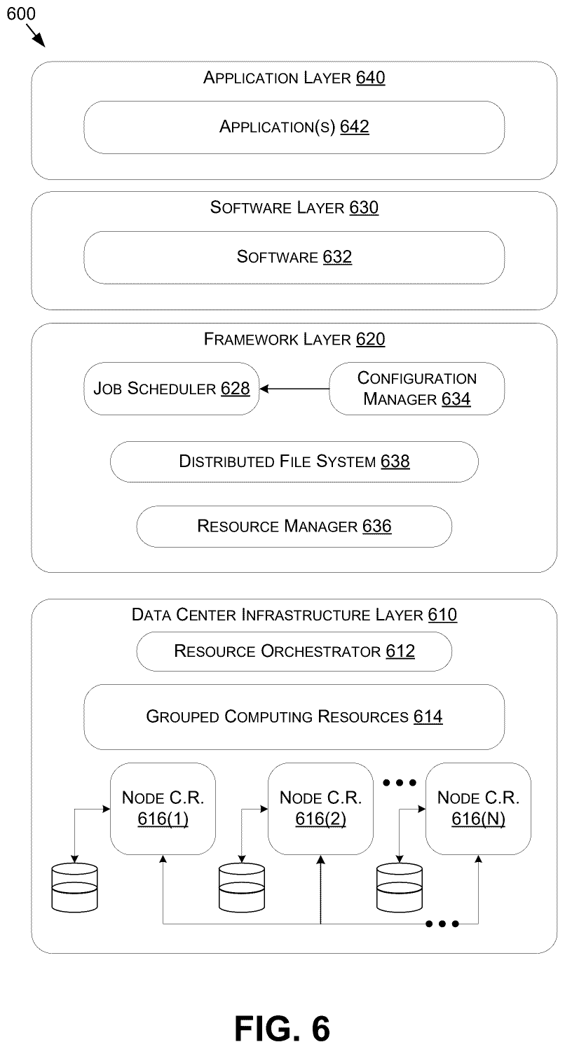

FIG. 6 illustrates an example data center 600 that may be used in at least one embodiment of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory, or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resources 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based at least on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software, or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or a combination thereof. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, the functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
identify, from a plurality of network packets corresponding to an encoded video stream, a subset of network packets corresponding to a region of a video frame of the encoded video stream;
generate at least one error correction packet for the subset of network packets that encode the region of the video frame; and
transmit, to a receiver client device, the plurality of network packets and the at least one error correction packet.

2. The processor of claim 1, wherein the plurality of network packets are transmitted via a user datagram protocol (UDP).

3. The processor of claim 1, wherein the encoded video stream is formatted in compliance with the real-time transport protocol (RTP).

4. The processor of claim 1, wherein the one or more circuits are to generate the encoded video stream.

5. The processor of claim 4, wherein the one or more circuits are to generate the plurality of network packets, at least one network packet of the plurality of network packets comprising a portion of the encoded video stream corresponding to the region of the video frame.

6. The processor of claim 1, wherein the one or more circuits are to identify the region of the video frame based at least on a configuration associated with the encoded video stream.

7. The processor of claim 1, wherein the region of the video frame comprises one or more slices or one or more tiles of the video frame.

8. The processor of claim 1, wherein the region is a selected region, and the one or more circuits are to:
allocate a first percentage of bandwidth for the encoded video stream to one or more first error correction packets for the subset of network packets that carry the selected region of the video frame; and
allocate a second percentage of bandwidth for the encoded video stream to one or more second error correction packets for a packet sequence that carries regions of the video frame other than the selected region.

9. The processor of claim 1, wherein the at least one error correction packet comprises forward error correction (FEC) data generated based at least on the subset of network packets.

10. The processor of claim 1, wherein the encoded video stream is encoded according to at least one codec standard from the list of codec standards comprising:
h.264;
h.265;
h.266;
VP8;
VP9; or
AV1.

11. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 4D assets;
a system for performing deep learning operations;
a system implemented using an edge device;
a system implemented using a robot;
a system for performing conversational AI operations;
a system for generating synthetic data;
a system incorporating one or more virtual machines (VMs);
a system incorporating one or more language models;
a system implemented at least partially in a data center; or
a system implemented at least partially using cloud computing resources.

12. A processor comprising:
one or more circuits to:
detect, based at least on a subset of a sequence of network packets received from a streaming server, that at least one network packet of the sequence of network packets was not successfully received by an intended receiver;
determine that the at least one network packet corresponds to a selected region of a video frame of a video stream; and
transmit a request for retransmission of the at least one network packet responsive to determining that the at least one network packet corresponds to the selected region and responsive to determining an available bandwidth allocation for retransmission of important regions of video and that a round-trip delay (RTD) to the streaming server is within a predetermined range.

13. The processor of claim 12, wherein the sequence of network packets is received via a user datagram protocol (UDP).

14. The processor of claim 12, wherein the video stream is formatted in compliance with the real-time transport protocol (RTP).

15. The processor of claim 12, wherein the one or more circuits are to delay or skip transmission of the request responsive to determining that the bandwidth allocation for retransmission of important regions of video has been exhausted or that the round-trip delay (RTD) to the streaming server is outside a predetermined range.

16. The processor of claim 12, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 4D assets;
a system for performing deep learning operations;
a system implemented using an edge device;
a system implemented using a robot;
a system for performing conversational AI operations;
a system for generating synthetic data;
a system incorporating one or more virtual machines (VMs);
a system incorporating one or more language models;
a system implemented at least partially in a data center; or
a system implemented at least partially using cloud computing resources.

17. A method, comprising:
identifying, by using one or more processors, from a plurality of network packets corresponding to an encoded video stream, a subset of network packets corresponding to a region of a video frame of the encoded video stream;
generating, using the one or more processors, at least one error correction packet for the subset of network packets that encode the region of the video frame; and
transmitting, using the one or more processors, to a receiver client device, the plurality of network packets and the at least one error correction packet.

18. The method of claim 17, wherein the plurality of network packets are transmitted via a user datagram protocol (UDP).

19. The method of claim 17, wherein the encoded video stream is formatted in compliance with the real-time transport protocol (RTP).

20. The method of claim 17, further comprising identifying, using the one or more processors, the region of the video frame based at least on a configuration associated with the encoded video stream.
